(19) United States
(12) Patent Application Publication
(10) Pub. No.: US 2019/0303752 A1
(43) Pub. Date: Oct. 3, 2019

(54) RF INTERFERENCE CATEGORIZATION USING MACHINE LEARNING

(71) Applicant: Hewlett Packard Enterprise Development LP, Houston, TX (US)

(72) Inventors: Mathieu Mercier, St. Laurent (CA); Andre Beaudin, St. Laurent (CA); Sachin Ganu, Santa Clara, CA (US); Dongwoon Hahn, Santa Clara, CA (US)

(21) Appl. No.: 15/937,381

(22) Filed: Mar. 27, 2018

(51) Int. Cl. G06N 3/08; H04B 17/345

(52) U.S. Cl. CPC G06N 3/08; H04B 17/345

(57) ABSTRACT

An example access point is described that includes a wireless transceiver, processing circuitry, and a non-transitory computer-readable medium comprising instructions. The instructions, when executed on the processing circuitry cause the processing circuitry to: receive a trained machine learning model that determines whether signals include interference patterns characteristic of a category of interference sources, receive a first signal including a first interference pattern, determine that the first interference pattern is an interference pattern characteristic of the category of interference sources, transmit information about the first signal including attributes of the first interference pattern and the determination that the first interference pattern is an interference pattern characteristic of the category of interference sources to the model training device, and receive an updated trained machine learning model that is updated based at least on the transmitted information about the first signal.

### BACKGROUND

Wireless access points transmit and receive signals on certain frequency bands. Each frequency band includes certain channels on which the signals are transmitted and received. In certain frequency bands (e.g. 5 GHz) some of the channels overlap frequencies that are often used for other purposes (e.g. weather and military radar). When a wireless access point transmits and receives signals on a channel overlapping frequencies being actively used by radar, the wireless transceiver of the wireless access point may receive a pattern of radio frequency (RF) pulses from the radar. Regulatory entities, such as the Federal Communications Commission, may require the wireless access point to change to a different channel when a radar is detected on the current channel.

Wireless access points that transmit and receive signals on frequency bands and channels that are also used by military and weather radar are required to implement Dynamic Frequency Selection (DFS), which allows the wireless access points to operate in the 5 GHz band alongside radar systems. Different regulatory bodies (e.g. the Federal Communications Commission) have different requirements for the implementation of DFS within a wireless access point.

### BRIEF DESCRIPTION OF THE DRAWINGS

For a more complete understanding of the present disclosure, examples in accordance with the various features described herein may be more readily understood with reference to the following detailed description taken in conjunction with the accompanying drawings, where like reference numerals designate like structural elements, and in which:

FIG. 1 illustrates an example access point;

FIG. 2 illustrates an example system for categorizing RF interference;

FIG. 3 is a flowchart illustrating an example method for categorizing RF interference;

FIG. 4 is a flowchart illustrating another example method for categorizing RF interference;

Certain examples have features that are in addition to or in lieu of the features illustrated in the above-referenced figures. Certain labels may be omitted from certain figures for the sake of clarity.

### DETAILED DESCRIPTION

When signals are received by a wireless transceiver (e.g. a wireless chipset), the received signals may each include an interference pattern. Each interference pattern includes attributes, such as peak magnitude and frequency. Certain interference patterns may include radio frequency (RE) pulses which have additional attributes, such as pulse duration, pulse separation (i.e. the time between successive pulses), and location of the pulse in a certain frequency band. In certain examples, the wireless transceiver monitors the received signals for interference patterns that exhibit attributes of interference that is generated by certain interference sources. For example, the wireless transceiver may monitor a received signal that has an interference pattern with a certain peak magnitude and a certain pulse separation. The wireless transceiver may then make a preliminary determination that the interference pattern possibly indicates the presence of a certain interference source. For example, the wireless transceiver may make a preliminary determination based on the certain peak magnitude and the certain pulse separation that a radar transmitter may be generating interference that is being received at the wireless transceiver. In some other examples, the certain interference source can be one of: a microwave transmitter, a Bluetooth transmitter, a Zigbee transmitter, or an analog device that operates in the same frequency band as WiFi.

Once the wireless transceiver identifies an interference potentially indicating the presence of a certain interference source, it sends the interference pattern to processing circuitry of the access point to further analyze the interference pattern. In certain examples, the processing circuitry includes a pre-filter and a trained machine learning model. The pre-filter makes another preliminary determination whether the interference pattern likely indicates the presence of a certain interference source. For example, the pre-filter may make a preliminary determination based on attributes of the interference pattern. Then, signals including interference patterns likely indicate the presence of a certain interference source are forwarded to the trained machine learning model for further analysis.

In certain examples, a model training device uses training data and attributes of the access point (e.g. wireless chipset model, regulatory region) to train a model for determining whether an interference pattern is characteristic of a certain interference source (or a certain category of interference sources). A model may be trained by a machine learning algorithm using training data consisting of attributes of interference patterns that have been previously determined either to be characteristic of a certain interference source or to not be characteristic of the certain interference source (or category of interference sources). In some examples, the model training device trains a long short-term memory neural network model. In some other examples, the model training device trains a hidden Markov model or any type of machine learning model appropriate for determining whether an interference pattern is characteristic of a certain interference source (or category of interference sources).

The trained machine learning model is transmitted to the access point and used by the access point to determine whether interference patterns forwarded to the trained machine learning model are characteristic of a certain interference source (or category of interference sources). In some examples, the trained machine learning model consists of a number of nodes that are coupled to one another through weighted interconnections. A first type of nodes is an input node which represents attributes of the interference pattern. A second type of node is an internal node that represents a weighted combination of input nodes. A third type of node is an output node that represents a determination made by the trained machine learning model. The topographical layout of the nodes in a trained machine learning model may take one of many different forms, including a binary tree, a graph, and linear.

The attributes of an interference pattern are inserted by the processing circuitry into the trained machine learning model (which also executes on the processing circuitry). The resultant determination is later transmitted, along with the attributes of the interference pattern, to the model training device for improving the trained machine learning model. If the trained machine learning model determines that the interference pattern is characteristic of a certain interference source (or category of interference sources), the processing circuitry executes instructions to undertake a remedial action. For example, if the trained machine learning model determines that the received interference pattern is characteristic of a first radar pattern type (e.g., a type of radar pattern defined by a regulatory agency) operating on the same frequency band and channel as the access point, the processing circuitry executes instructions to change to a different channel within the frequency band.

After a period of time, the model training device creates an updated trained machine learning model using information including the resultant determination and attributes of the interference pattern that were transmitted to the model training device. In various examples, the model training device may train a set of models for access points of different deployment scopes, including site-wide, enterprise-wide, regulatory region-wide, or even globally. In various examples, the model training device may train different models for different access points, including, for example, based on access point model, wireless chipset, or class of access point model. The model training device transmits the updated trained machine learning model (which has been retrained accounting for the information sent from the access point and possibly other access points in the same network) to the access point. The access point then replaces the trained machine learning model with the updated trained machine learning model. In some examples, the updated trained machine learning model can be “hot swapped”, replacing the trained machine learning model without powering down the access point.

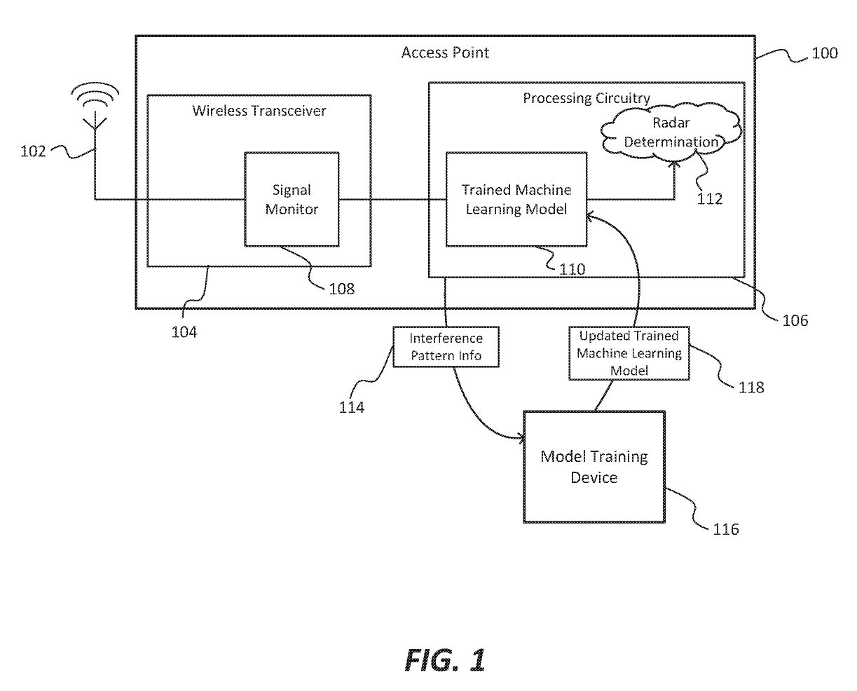

FIG. 1 illustrates an example wireless access point. Access point 100 includes an antenna 102, a wireless transceiver 104, and processing circuitry 106. Wireless transceiver 104 includes a signal monitor 108. Processing circuitry 106 includes a trained machine learning model 110 and a radar determination 112. Access point 100 is communicatively coupled to a model training device 116 and transmits interference pattern information 114 from processing circuitry 106 to the model training device 116. Access point 100 also receives an updated trained machine learning model 118 from model training device 116.

In some examples, access point 100 is configured to transmit and receive wireless signals through antenna 102. When operating in a certain wireless frequency band, access point 100 transceives signals on a certain channel within the wireless frequency band. In some frequency bands (e.g. 5 GHz), some channels may overlap with operating channels in other types of network. For example, access point 100 may transmit and receive signals on a channel that overlaps a frequency used by a nearby weather radar.

Certain regulatory agencies, such as the Federal Communications Commission (FCC) in the United States and the European Telecommunications Standards Institute (ETSI) in Europe, require by regulation that access points (including access point 100) monitor received signals on the operating channel of the access point for interference patterns indicating the presence of a radar transmitter on frequencies within the same channel. While each regulatory agency has its own requirements for handling the detection and amelioration of a channel conflict with a radar transmitter, regulations generally require access points to pass a laboratory test for the detection portion and set requirements for how the amelioration portion operates. For example, a certain regulatory agency may require an access point to correctly detect 85% of simulated radar interference patterns in a laboratory test before being certified for operation, and the certain regulatory agency may require that an access point vacate a channel overlapping a radar transmitter's output and notify all connected devices of the change in channel within one second of detection of the radar transmitter.

When wireless transceiver 104 is configured to send and receive signals via antenna 102 on a certain channel of a certain frequency band, signal monitor 108 monitors the received signals for interference patterns with attributes of a certain category of interference sources. An example interference pattern may be a series of radio frequency (RF) pulses in the frequency band and channel access point 100 is operating on that are not from a device associated with the access point. In some examples, interference patterns may be generated by other nearby access points operating on the same or an overlapping channel. Interference patterns can also be generated by military or weather radar operating on a frequency within the channel in use by access point 100.

Once signal monitor 108 detects a signal that possibly originates from the certain category of interference sources, attributes of the signal are forwarded to processing circuitry 106 for more detailed analysis. In some examples, processing circuitry 106 includes at least one pre-filter (not shown) that forwards signals with interference patterns likely originating from the certain category of interference sources to trained machine learning model 110. In some examples, trained machine learning model 110 is forwarded the received signal with an interference pattern likely originating from the certain category of interference sources. In some other examples, trained machine learning model 110 is forwarded attributes of the interference pattern of the received signal.

Trained machine learning model 110 is created and trained by model training device 116. Model training device 116 includes training data and attributes of access point 100 that are used to train machine learning model 110. In some examples, machine learning model 110 includes weighted nodes. In certain examples, there are three types of weighted nodes: input nodes, internal nodes, and output nodes. Input nodes may represent attributes of the interference pattern. Internal nodes may represent a weighted combination of input nodes. Output nodes may represent a determination made by the trained machine learning model. Each weighted node can be adjusted so that the input to the weighted node is weighted by the weight of the weighted node. For example, in a simple network of nodes consisting of two input nodes feeding into one output node, a first input node weighted at 0.8 may receive a signal of 6 and a second input node weighted at 0.25 may receive a signal of 2. The output node may sum the resultant weighted signals from the input nodes (0.8×6, or 4.8, for the first input node, and 0.25×2, or 0.5, for the second input node) for an output signal of 5.3. The output node may, for example, compare the output signal, 5.3, to a threshold and output a binary determination of whether the output signal exceeds the threshold. Model training device 116 uses the training data and the attributes of access point 100 as inputs into machine learning model 110, and adjusts weights of weighted nodes of machine learning model 110 to heuristically determine whether signals received at access point 100 originate from the certain category of interference sources.

In some examples, model training device 116 uses training data that includes attributes of received signals and determinations whether the signals originate from the certain category of interference sources. Model training device 116 then adjusts the weights of nodes in machine learning model 110 so that radar determination 112 output from machine learning model 110 for a given signal more closely matches the respective determination whether the signal originates from the certain category of interference sources. As an example, if a certain test case included in the training data includes a first set of attributes corresponding to a first signal, along with a determination that the first signal originated from a radar transmitter, model training device 116 will input the first set of attributes corresponding to the first signal into machine learning model 110. In this example, machine learning model 110 is either not yet trained or only partially trained. Machine learning model 110 makes a radar determination 112 based on the signal attributes input during training by model training device 116. Model training device 116 compares radar determination 112 to the determination that the first signal originated from a radar transmitter. Depending on the specific design of machine learning model 110, if radar determination 112 reflects the fact that the first signal originated from a radar transmitter, model training device 116 signals a successful determination to machine learning model 110. If radar determination 112 does not reflect the fact that the first signal originated from a radar transmitter, model training device 116 may signal a failed determination to machine learning model 110. In some examples, machine learning model 110 may be trained by adjusting weights of its weighted nodes based on the success or failure signal from model training device 116. In some examples, signal attributes provided as input to machine learning model 110 are associated with a certain wireless chipset or a certain access point. In certain examples, radar determination 112 includes more than a mere binary determination whether a signal originated from a radar transmitter. For example, radar determination 112 may include a determination of a specific type of radar transmitter, a likelihood of the signal originating from a radar transmitter, or any other appropriate information that can be determined about the origin of the signal.

Once machine learning model 110 has been trained, model training device 116 transmits trained machine learning model 110 to access point 100. Access point 100 then uses trained machine learning model 110 to generate radar determinations 112 about signals received at antenna 102. In some examples, access point 100 uses a positive radar determination 112 (i.e. a determination that a signal originated from a radar transmitter) to initiate appropriate action based on the local regulatory requirements. For example, access point 100 may, upon receiving a positive radar determination 112, notify all connected devices that access point 100 is changing to a different channel of the frequency band and execute the change to the different channel all within one second of receiving the positive radar determination 112.

Access point 100 transmits interference pattern info 114 to model training device 116. In some examples, once a radar determination 112 is made for a signal, attributes of the signal and the radar determination 112 are sent as interference pattern info 114 to model training device 116. In some other examples, access point 100 periodically sends attributes and radar determinations 112 for a number of signals to model training device 116. Certain example model training devices 116 receive interference pattern info 114 from multiple access points 100 at a certain site. Some other example model training devices 116 receive interference pattern info 114 from multiple access points 100 at multiple sites across an enterprise's network. Yet other example model training devices 116 receive interference pattern info 114 from access points 100 across a region or even globally.

Model training device 116 includes interference pattern info 114 into a new set of training data that is used to train an updated trained machine learning model 118. Interference pattern info 114 may be validated and corrected prior to being used to update updated trained machine learning model 118 through training. For example, interference pattern info 114 may be reviewed by a computing device using an algorithm to heuristically determine, based on interference pattern info 114 of access point 100 and other interference pattern info of other access points, whether radar determination 112 is valid or invalid. As another example, an expert may manually review interference pattern info 114 to determine whether radar determination 112 is valid or invalid. The expert may correct radar determination 112 if found invalid. Although automated and manual examples of interference pattern info 114 validation and correction are described, any method of validating and correcting interference pattern info 114 prior to being used to train updated trained machine learning model 118 is contemplated, including semi-automated methods. In some examples, a copy of trained machine learning model 110 is updated using the new set of training data including interference pattern info 114. In some other examples, a new trained machine learning model 118 is trained using the same training data used to train machine learning model 110 as well as the new set of training data. Once updated trained machine learning model 118 is trained, model training device 116 transmits updated trained machine learning model 118 to access point 100 to replace trained machine learning model 110. In some examples, updated trained machine learning model 118 is transmitted to all access points that include the same wireless chipset as access point 100.

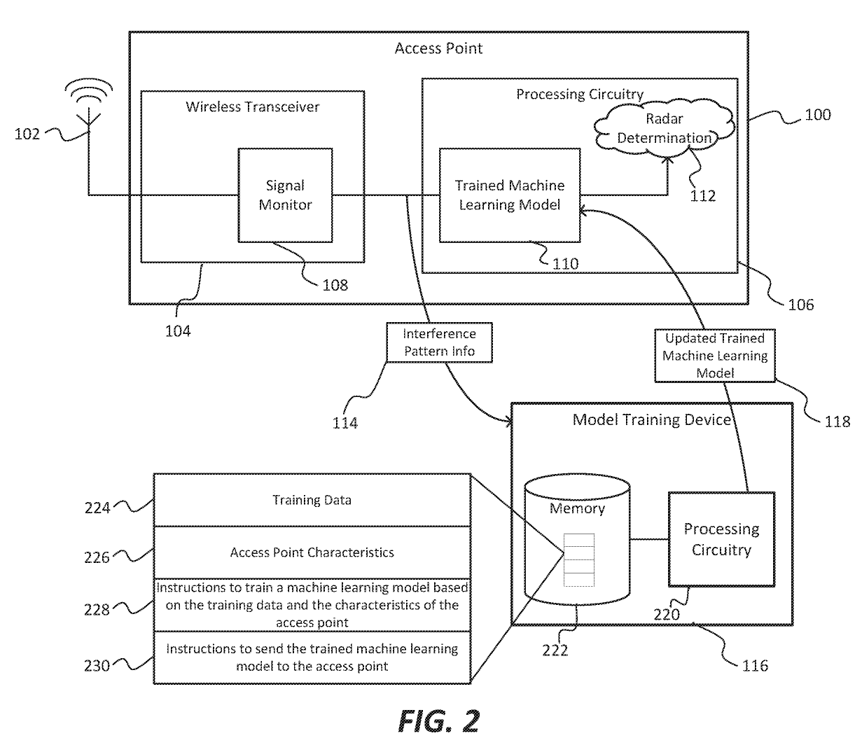

FIG. 2 illustrates an example system for categorizing RF interference. In the interest of clarity, FIG. 2 will be described in relation to an example operation of the example system. Specific description of an example operation of the example system of FIG. 2 is meant only to clarify a possible operation of the system, and should not be construed to limit this disclosure.

Model training device 116 includes processing circuitry 220 and memory 222. Memory 222 includes training data 224, access point characteristics 226, instructions 228 to train a machine learning model, and instructions 230 to send the trained machine learning model to access point 100. Instructions 228 to train the machine learning model do so based on training data 224 and access point characteristics 226.

The following describes an example operation of the example system in FIG. 2. Access point 100, upon initialization, communicatively couples with model training device 116. In some examples, this communicative coupling is indirect, dependent upon administrator intervention (e.g. an administrator manually passes data between access point 100 and model training device 116). In some other examples, access point 100 directly (e.g. through hops of a wired, wireless, or hybrid network connection) communicates with model training device 116. Model training device 116 trains a machine learning model 110 using training data 224 and access point characteristics 226 by executing instructions 228 on processing circuitry 220. In certain examples, model training device 116 trains multiple machine learning models 110, one machine learning model 110 for each set of access point characteristics 226. For example, a first machine learning model 110 may be trained for a first class of access points 100 with first access point characteristics 226 (e.g. using a first wireless chipset) and a second machine learning model 110 may be trained for a second class of access points 100 with second access point characteristics 226 (e.g. using a second wireless chipset). After machine learning model 110 has been trained by model training device 116, trained machine learning model 110 is transmitted to access point 100 for use in making radar determinations 112. In some examples, an administrator may download trained machine learning model 110 from a website associated with model training device 116 and install trained machine learning model 110 on access point 100. In some other examples, access point 100 requests trained machine learning model 110 from model training device 116, and in response, model training device 116 transmits trained machine learning model 110 to access point 100.

As access point 100 receives signals on antenna 102, information about interference patterns of the signals that are forwarded to trained machine learning model 110, as well as their respective radar determinations 112 are stored. Periodically, access point 100 transmits the information about the interference patterns as well as the radar determinations 112 to model training device 116 in the form of interference pattern info 114. In the currently discussed example operation, model training device 116 trains models for access points within a geographical region regulated by a certain regulatory authority. Model training device 116 receives interference pattern info from many access points within the region, including access points with different wireless chipsets that access point 100. Model training device 116 stores interference pattern info 114 from access point :1.00 along with interference pattern info from other access points containing the same wireless chipset as access point 100. This interference pattern info is stored as a new portion of training data 224.

Periodically, model training device 116 uses the new portion of training data 224 and access point characteristics 226 to update the machine learning model for access point 100 (and other access points with the same wireless chipset). Model training device 116 trains a copy of trained machine learning model 110 using the new portion of training data 224 (which includes interference pattern info 114) by executing instructions 228. Once updated trained learning machine model 118 is fully trained, model training device 116 executes instructions 230 to send updated trained machine learning model 118 to access point 100 (and to the other access points containing the same wireless chipset). In some examples, model training device 116 may later update another trained machine learning model for access points containing a different wireless chipset using different training data and different access point characteristics.

In some examples, the trained machine learning model 110 of access point 100 is “hot swappable.” In such examples, updated trained machine learning model 118 replaces trained machine learning model 110 without requiring access point 100 to restart or enter a non-operational mode.

While the example operation of FIG. 2 describes the operation in certain ways (e.g. a region-wide model training device, periodic updating of the machine learning model, etc.), this disclosure contemplates the example system operating in any appropriate manner.

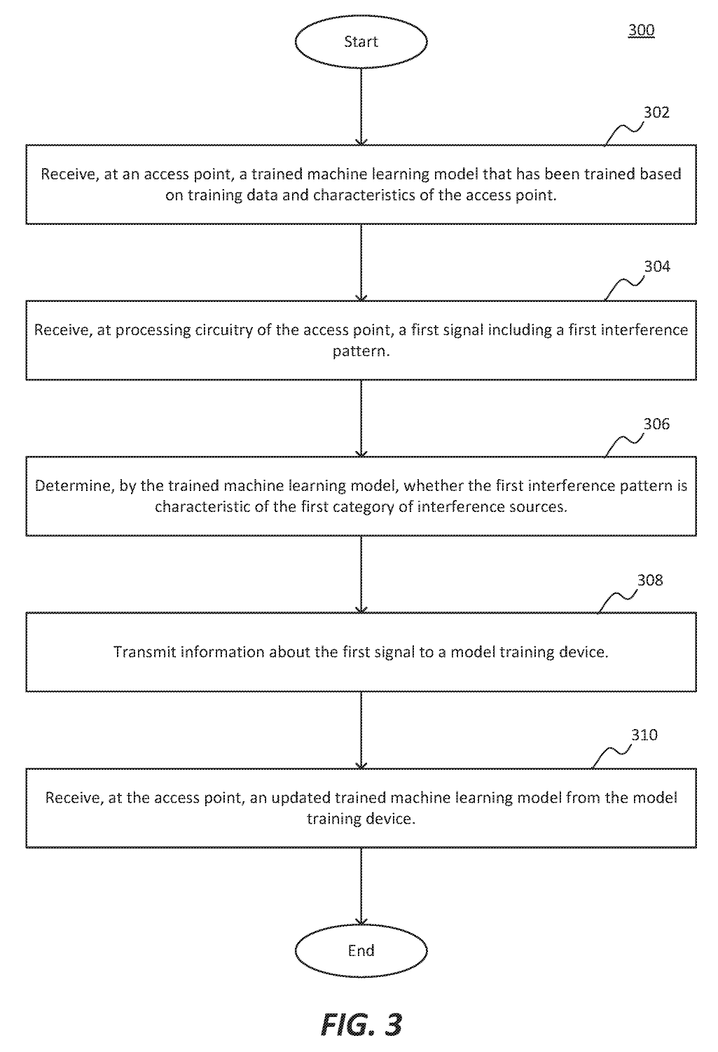

FIG. 3 is a flowchart illustrating an example method for categorizing RF interference. Method 300 describes an example procedure for using a trained machine learning model to detect RF interference from a category of interference sources.

At block 302, an access point receives a trained machine learning model that has been trained based, in part, on training data and characteristics of the access point. In some examples, the trained machine learning model is trained to be used by all access points containing a certain wireless chipset. The training data may include attributes of previously detected signals and determinations whether each previously detected signal originated from a first category of interference sources.

At block 304, processing circuitry of the access point receives a first signal including a first interference pattern. In some examples, a wireless transceiver of the access point receives the first signal and forwards attributes of the first interference pattern to the processing circuitry.

At block 306, the trained machine learning model determines whether the first interference pattern is characteristic of the first category of interference sources. In some examples, the first category of interference sources includes radar transmitters. The trained machine learning model may further determine a subcategory of the first category of interference sources that the first interference pattern is characteristic of. For example, the trained machine learning model may determine that the first interference pattern is characteristic of a radar transmitter (the first category), and specifically a FCC radar type 4 (the subcategory). In some examples, the processing circuitry includes a pre-filter that removes interference patterns that are not likely to be characteristic of the first category of interference sources prior to being received by the trained machine learning model.

At block 308, information about the first signal is transmitted to a model training device. In some examples, information about multiple signals that have been processed by the trained machine learning model are stored by the access point and periodically transmitted together to the model training device. In certain examples, the information about the first signal includes attributes of the first interference pattern and the determination whether the first interference pattern (which includes RF pulses) is characteristic of the first category of interference sources. For example, the information about the first signal may include time difference between RF pulses, RF pulse duration, whether RF pulses are at the edge of the frequency band, the frequency offset of the interference pattern from the center of the band, the peak magnitude, the total radio gain, the baseband radio gain, the in-band/out-band ratio, and the determination whether the interference pattern is characteristic of a radar transmitter.

At block 310, the access point receives an updated trained machine learning model from the model training device. In some examples, the updated trained machine learning model is a copy of the trained machine learning model that has been additionally trained using, in part, the information about the first signal that was transmitted to the model training device in block 308. In some examples, the updated trained machine learning model replaces the trained machine learning model in the access point without requiring the access point to restart or enter a non-operational mode.

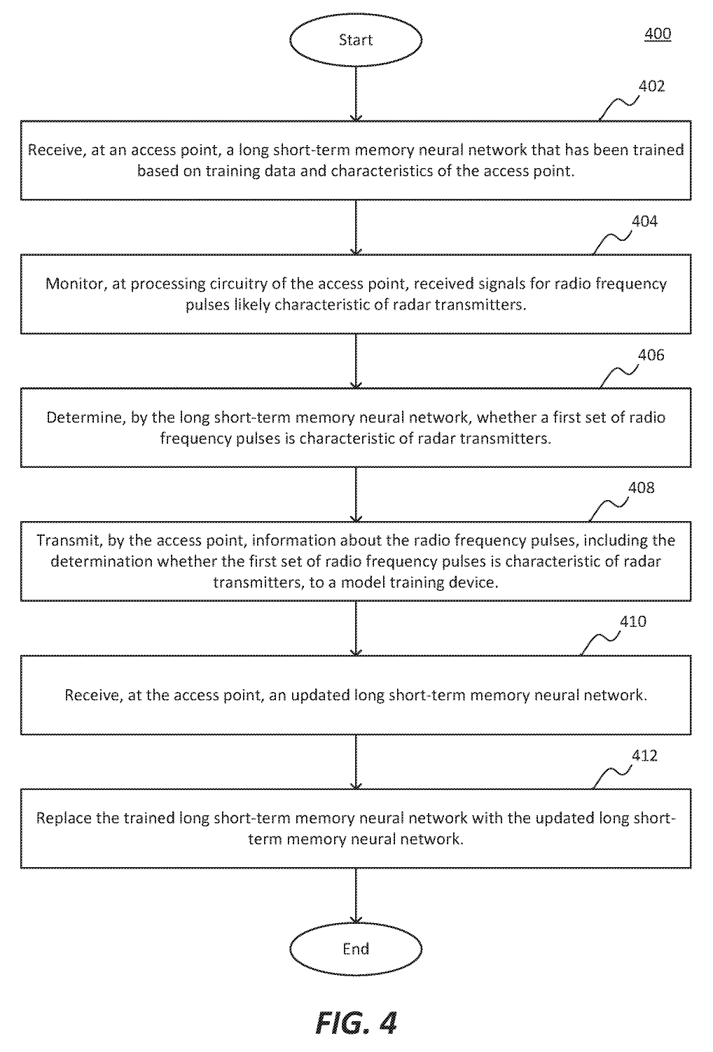

FIG. 4 is a flowchart illustrating another example method for categorizing RE interference. Method 400 describes an example procedure for using a trained machine learning model to detect RF interference from a category of interference sources.

In block 402, an access point receives a long short-term memory neural network that has been trained based, in part, on training data and characteristics of the access point. In some examples, the long short-term memory neural network is trained to be used by all access points containing a certain wireless chipset. The training data may include attributes of previously detected signals and determinations whether each previously detected signal originated from a first category of interference sources.

In block 404, processing circuitry of the access point monitors received signals for RF pulses that are likely characteristic of radar transmitters. In some examples, the processing circuitry receives attributes of RF pulses that have been determined to be possibly characteristic of radar transmitters from a wireless transceiver of the access point. In some other examples, the portion of the processing circuitry monitoring the received signals is collocated with the wireless transceiver on the same integrated circuit (e.g. the wireless chipset). In certain examples, the wireless chipset monitors received signals and executes a first pre-filter and forwards certain received signals to a second pre-filter executed by processing circuitry not a part of the wireless chipset, which then forwards certain of the received signals to the long short-term memory neural network.

In block 406, the long short-term memory neural network determines whether a first set of RF pulses (i.e. an interference pattern) is characteristic of radar transmitters. The long short-term memory neural network may further determine a subcategory of radar transmitters that the first set of RE pulses is characteristic of. For example, the long short-term memory neural network may determine that the first set of RE pulses is characteristic of a radar transmitter, and specifically a FCC radar type 4. In some examples, the processing circuitry includes a pre-filter that removes sets of RE pulses that are not likely to be characteristic of radar transmitters prior to being received by the long short-term memory neural network. The long short-term memory neural network may use attributes of the set of RE pulses to make the determination, including: time difference between RF pulses, RF pulse duration, whether RE pulses are at the edge of the frequency band, the frequency offset of the interference pattern from the center of the band, the peak magnitude, the total radio gain, the baseband radio gain, and the in-band/out-band ratio.

In block 408, the access point transmits information about the RE pulses, including the determination whether the first set of RE pulses is characteristic of radar transmitters, to a model training device. In some examples, information about multiple sets of RE pulses that have been processed by the long short-term memory neural network are stored by the access point and periodically transmitted together to the model training device. In certain examples, the information about the first set of RF pulses includes attributes of the first set of RE pulses and the determination whether the first set of RE pulses is characteristic of radar transmitters.

In block 410, the access point receives an updated long short-term memory neural network from the model training device. In some examples, the updated long short-term memory neural network is a copy of the long short-term memory neural network that has been additionally trained using, in part, the information about the first set of RE pulses that was transmitted to the model training device in block 408. In some examples, the updated long short-term memory neural network replaces the long short-term memory neural network in the access point without requiring the access point to restart or enter a non-operational mode.

In block 412, the access point replaces the trained long short-term memory neural network with the updated long short-term memory neural network. In some examples, the access point “hot swaps” the updated long short-term memory neural network by replacing it without requiring a restart of the access point or entering a mode that does not allow the access point to transmit and receive wireless signals for an extended period of time.

In some portions of this disclosure, the wireless transceiver of the access point and the processing circuitry of the access point are described as discrete units. This disclosure contemplates any physical configuration of a wireless transceiver and processing circuitry, including separate physical components, combined within one physical component, as virtualized units in a virtualization system, or any other appropriate implementation.

Although the present disclosure has been described in detail, it should be understood that various changes, substitutions and alterations can be made without departing from the spirit and scope of the disclosure. Any use of the words “may” or “can” in respect to features of the disclosure indicates that certain examples include the feature and certain other examples do not include the feature, as is appropriate given the context. Any use of the words “or” and “and” in respect to features of the disclosure indicates that examples can contain any combination of the listed features, as is appropriate given the context.

Phrases and parentheticals beginning with “e.g.” are used to provide examples merely for the purpose of clarity. It is not intended that the disclosure be limited by the examples provided in these phrases and parentheticals. The scope and understanding of this disclosure may include certain examples that are not disclosed in such phrases and parentheticals.

1. An access point, comprising:
a wireless transceiver; and
a non-transitory computer-readable medium comprising instructions that, when executed, cause processing circuitry to:
receive, from a model training device, a trained machine learning model that determines whether signals include interference patterns characteristic of a category of interference sources;
receive, from the wireless transceiver, a first signal including a first interference pattern;
determine, using the trained machine learning model, that the first interference pattern is an interference pattern characteristic of the category of interference sources;
transmit information about the first signal including attributes of the first interference pattern and the determination that the first interference pattern is an interference pattern characteristic of the category of interference sources to the model training device; and
receive, from the model training device, an updated trained machine learning model that is updated based at least on the transmitted information about the first signal.

2. The access point of claim 1, wherein the category of interference sources includes radar transmitters.

3. The access point of claim 2, wherein the processing circuitry further determines that the first interference pattern is an interference pattern characteristic of a certain type of radar transmitters.

4. The access point of claim 1, wherein the attributes of the first interference pattern include at least one of: a time differential between pulses of the first interference pattern, duration of a pulse of the first interference pattern, a frequency of the pulse relative to a frequency band, a frequency offset of the pulse relative to a center of the frequency band, a peak magnitude of the first interference pattern, a total radio gain of the first interference pattern, a baseband radio gain of the first interference pattern, or an in-band/out-band ratio of the first interference pattern.

5. The access point of claim 1, wherein the processing circuitry is further to replace the trained machine learning model with the updated trained machine learning model.

6. The access point of claim 1, wherein the processing circuitry is further to prefilter a second signal including a second interference pattern that is not characteristic of the category of interference sources.

7. A method, comprising:
receiving, at an access point, a trained machine learning model that has been trained based, in part, on training data and characteristics of the access point;
monitoring, at processing circuitry of the access point, received signals for interference patterns characteristic of a first category of interference sources;
determining, by the trained machine learning model, whether a first interference pattern is characteristic of the first category of interference sources;
transmitting, to a model training device, information about the first interference pattern;
receiving, at the access point, an updated trained machine learning model; and
replacing the trained machine learning model with the updated trained machine learning model.

8. The method of claim 7, wherein the first category of interference sources includes radar transmitters.

9. The method of claim 7, wherein the first interference pattern comprises a plurality of radio frequency pulses.

10. The method of claim 7, wherein transmitting information about the first interference pattern includes the determination whether the first interference pattern is characteristic of the first category of interference sources.

11. The method of claim 7, wherein the trained machine learning model is a long short-term memory neural network.

12. The method of claim 7, wherein the characteristics of the access point include a wireless chipset of the access point and a geographical region of the access point.

13. The method of claim 12, wherein the trained machine learning model complies with interference source detection regulations of the geographical region of the access point.

14. A system, comprising:
a model training device, comprising:
a memory including training data, characteristics of an access point, and instructions that, when executed by processing circuitry, cause the processing circuitry to:
train a machine learning model based on the training data and the characteristics of the access point;
send the trained machine learning model to the access point;
receive information about the first interference pattern from the access point;
train an updated machine learning model based, in part, on the information about the first interference pattern received from the access point; and
transmit the updated trained machine learning model to the access point; and
the access point, comprising:
a wireless transceiver; and
processing circuitry communicatively coupled to the wireless transceiver to:
monitor received signals for interference patterns characteristic of a first category of interference sources;
receive the trained machine learning model;
determine, using the trained machine learning model, whether a first interference pattern of a first received signal is characteristic of the first category of interference sources; and
transmit information about the first interference pattern, including the determination whether the first interference pattern is characteristic of the first category of interference sources, to the model training device.

15. The system of claim 14, wherein the information about the first interference pattern includes at least one of: a time differential between pulses of the first interference pattern, duration of a pulse of the first interference pattern, a frequency of the pulse relative to a frequency band, a frequency offset of the pulse relative to a center of the frequency band, a peak magnitude of the first interference pattern, a total radio gain of the first interference pattern, a baseband radio gain of the first interference pattern, or an in-band/out-band ratio of the first interference pattern.

16. The system of claim 14, wherein the model training devices trains long short-term memory neural networks.

17. The system of claim 14, wherein the first category of interference sources includes radar transmitters.

18. The system of claim 14, wherein the model training device sends the trained machine learning model to a plurality of access points with characteristics similar to the characteristics of the access point.

19. The system of claim 18, wherein the characteristics of the access point include a wireless chipset of the access point and a geographical region of the access point.

20. The system of claim 18, wherein the trained machine learning model and the updated trained machine learning model comply with interference source detection regulations of the geographical region of the access point.
